(19) United States
(12) Patent Application Publication
(10) Pub. No.: US 2019/0270044 A1
(43) Pub. Date: Sep. 5, 2019

(54) Information-equipped Filter and Method of Making the Same

(71) Applicant: Stephen Hoke, Redding, CA (US)

(72) Inventor: Stephen Hoke, Redding, CA (US)

(21) Appl. No.: 16/287,297

(22) Filed: Feb. 27, 2019

Related U.S. Application Data
(60) Provisional application No. 62/637,325, filed on Mar. 1, 2018.

(51) Int. Cl. B01D 46/00; B01D 46/24

(52) U.S. Cl. CPC B01D 46/0086; B01D 2279/30; B01D 46/0001; B01D 46/2418

(57) ABSTRACT

Embodiments are provided for an information-equipped filter, method of making said filter, and method of determining when an information-equipped filter is clean. Additionally, a data tag is located on the outer shell of the information-equipped filter that displays the weight of the filter on the day it was manufactured, allowing a user of the filter to determine how much ash and soot has built up inside of the filter during use. The weight of the filter measured on the day it was manufactured can be measured after removing moisture from the filter using heat.

### CROSS-REFERENCE TO RELATED APPLICATIONS

This application claims priority to U.S. Provisional Application No. 62/637,325 filed Mar. 1, 2018, which is incorporated by reference in its entirety.

### FIELD OF THE DISCLOSURE

This present invention relates to an information-equipped filter, system, and method for use as a filter and the like and for purifying exhaust gases discharged from an internal combustion engine such as a diesel engine or the like.

### BACKGROUND

There have been proposed various honeycomb filters for purifying exhaust gases and catalyst supporting members, which are used for purifying the exhaust gases from internal combustion engines of vehicles such as trucks, buses and the like, and transportation vehicles.

Specifically, for example, a honeycomb filter for purifying exhaust gases is provided in U.S. patent application Ser. No. 11/225,197. In that application, a honeycomb filter for purifying exhaust gases with a plurality of silicon carbide honeycomb members that are combined with sealing material layers to form a honeycomb block is disclosed. Further, the patent application discloses manufacturing information regarding the honeycomb structured body on a circumferential surface by using a two-dimensional code.

Additionally, there have been proposed various applications in which a honeycomb structured body, which comprises a honeycomb unit comprising a plurality of cells longitudinally placed in parallel with each other with a cell wall therebetween, is used as filters for capturing particulate matter in exhaust gases to purify the exhaust gases. Moreover, with respect to the honeycomb structured body of this type, there has been also proposed a catalyst supporting member in which a catalyst is supported inside the through holes, with the ends of the through holes being not sealed.

However, during the use of these honeycomb structured filters, it is important to keep these filters clean, as over time, these particulate matter filters become clogged with soot and ash and must be cleaned to maintain air flow and prevent loss of engine power, poor fuel economy, and engine damage to name some of the consequences. However, when cleaning the filter, a person cleaning the filter traditionally is not able to determine how much soot and ash has been removed from the filter and how much remains clogged in the filter. This is because they do not know how much the filter weighed when it was originally manufactured.

U.S. Pat. No. 9,874,132 disclosed electric-heating type heaters, having a tubular honeycomb structure and a plurality of cells, which become through channels for a fluid, used to raise a temperature of a catalyst to an operation temperature having visual indicia that provides information concerning the heater's performance. However, this patent provides heating performance information, including resistance value, the NTC characteristics, and the heat generation speed in order to inform a user of the electric heaters performance. Although this device deals with a heater, information about the device's original weight at the time of manufacturing for purposes of cleaning the device at a later date is taught. Additionally, the provided information does not assist with maintaining optimal air flow through the device and is meant to assist in the manufacturing of the device.

Due to all of the existing shortcoming in presently available devices, there is a need for a filter device that is equipped with information of the weight of the filter at the time of manufacturing.

### SUMMARY

The disclosure presented herein relates to an information-equipped filter having an inner tubular body that is comprised of a honeycomb structure that has a tubular body made of a porous ceramic material that has at least one channel extending through the filter. The outer shell of the filter is fitted with a data label attached. The data label includes visual indicia which provides information concerning the filter's weight. In one or more non-limiting examples, one or more embodiments herein may be used as an information-equipped filter that provides a user of said filter with information concerning the weight on the date said filter was manufactured. Those of ordinary skill will appreciate that other uses may be foreseeable also and are included within the scope of the present description.

In one aspect, one or more embodiments for a method of weighing a filter having a tubular body, recording said filter's weight information, and applying said recorded weight information onto said filter is provided.

In another aspect, the present disclosure provides for a method of determining when an information-equipped filter is clean, the method including the steps of removing said filter from an engine, reading the filters weight from the time of being manufactured from a label located on said filter, and cleaning said filter until said filter weight is substantially close to said filter's labeled weight.

The information-equipped filter is suitable for use with combustion engines and for purifying exhaust gasses discharged from these engines. After removing a particulate filter from a combustion engine, these filters are often clogged with soot, and once it oxidizes it becomes ash, and other particulate matter that the filter removed from exhaust gases. When a user tries to clean the filter, they do not know the weight the filter originally weighed when it was manufactured, and therefore are not able to determine when the filter is clean based on the filter weight. The present filter provides an option for a user to weigh the information-equipped filter during the cleaning process and determine when the filter is clean based off of the filter's weight.

The preceding and following embodiments and descriptions are for illustrative purposes only and are not intended to limit the scope of this disclosure. Other aspects and advantages of this disclosure will become apparent from the following detailed description.

### Definitions

PM stands for particulate matter (also called particle pollution): the term for a mixture of solid particles and liquid droplets found in the air. Most particles form in the atmosphere as a result of complex reactions of chemicals such as sulfur dioxide and nitrogen oxides, which are pollutants emitted from power plants, industries and automobiles.

Soot is a black powdery or flaky substance consisting largely of amorphous carbon, produced by the incomplete burning of organic matter.

The date of manufacture is the date on which a product becomes the item it is supposed to be, or as it is described in it specifications or technical literature.

The born-on weight is the weight of the desired object to be weighed on the date of manufacture after substantially removing any excess moisture in said object.

### BRIEF DESCRIPTION OF THE DRAWINGS

Embodiments of the present disclosure are described in detail below with reference to the following drawings. These and other features, aspects, and advantages of the present disclosure will become better understood with regard to the following description, appended claims, and accompanying drawings. The drawings described herein are for illustrative purposes only of selected embodiments and not all possible implementations and are not intended to limit the scope of the present disclosure.

FIG. 1 is an isometric view of an exemplary information-equipped filter according to various aspects of the present disclosure.

FIG. 2 is a front view of an exemplary information-equipped filter according to various aspects of the present disclosure.

FIG. 3 is a front view of a data label according to various aspects of the present disclosure.

FIG. 4 depicts a diagram showing the operational steps taken to apply the manufacturing weight onto a filter according to various aspects of the present disclosure.

FIG. 5 is a flow chart for an exemplary process for determining how much soot and ash is removed from a diesel particulate filter after cleaning.

### DETAILED DESCRIPTION

In the Summary above and in this Detailed Description, and the claims below, and in the accompanying drawings, reference is made to particular features (including method steps) of the invention. It is to be understood that the disclosure of the invention in this specification includes all possible combinations of such particular features. For example, where a particular feature is disclosed in the context of a particular aspect or embodiment of the invention, or a particular claim, that feature can also be used, to the extent possible, in combination with and/or in the context of other particular aspects and embodiments of the invention, and in the invention generally.

The term “comprises” and grammatical equivalents thereof are used herein to mean that other components, ingredients, steps, among others, are optionally present. For example, an article “comprising” (or “which comprises”) components A, B, and C can consist of (i.e., contain only) components A, B, and C, or can contain not only components A, B, and C but also contain one or more other components.

Where reference is made herein to a method comprising two or more defined steps, the defined steps can be carried out in any order or simultaneously (except where the context excludes that possibility), and the method can include one or more other steps which are carried out before any of the defined steps, between two of the defined steps, or after all the defined steps (except where the context excludes that possibility).

The term “at least” followed by a number is used herein to denote the start of a range beginning with that number (which may be a range having an upper limit or no upper limit, depending on the variable being defined). For example, “at least 1” means 1 or more than 1. The term “at most” followed by a number (which may be a range having 1 or 0 as its lower limit, or a range having no lower limit, depending upon the variable being defined). For example, “at most 4” means 4 or less than 4, and “at most 40%” means 40% or less than 40%. When, in this specification, a range is given as “(a first number) to (a second number)” or “(a first number)-(a second number),” this means a range whose limit is the second number. For example, 25 to 100 mm means a range whose lower limit is 25 mm and upper limit is 100 mm.

Certain terminology and derivations thereof may be used in the following description for convenience in reference only, and will not be limiting. For example, words such as “upward,” “downward,” “left,” and “right” would refer to directions in the drawings to which reference is made unless otherwise stated. Similarly, words such as “inward” and “outward” would refer to directions toward and away from, respectively, the geometric center of a device or area and designated parts thereof. References in the singular tense include the plural, and vice versa, unless otherwise noted.

The present description includes one or more embodiments for an information-equipped filter that may include a data label on the circumferential wall of said filter depicting the weight of said filter on the date said filter was manufactured. The one or more embodiments for an information-equipped filter include multiple elements for the position of a data label, and methods of applying the weight of the filter at the time it was manufactured, in indicia, to the exterior surface of a filter. For example, in one or more embodiments, the components that make up the data label are located on the outer shell of the filter. Elements included herein are meant to be illustrative, rather than restrictive. Persons having ordinary skill in the art relevant to the present disclosure may understand there to be equivalent elements that may be substituted with the present disclosure without changing the essential function or operation of the device.

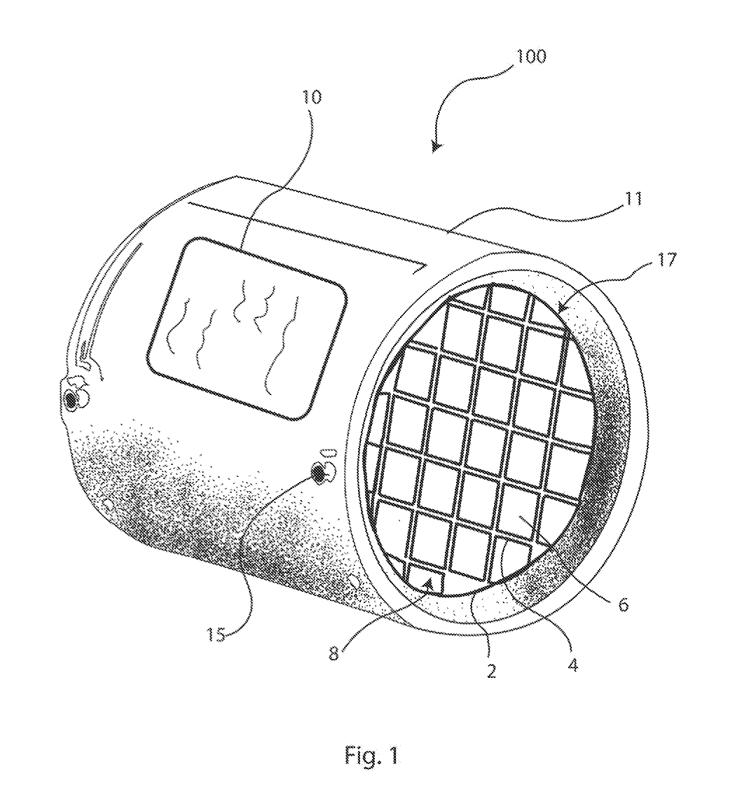

Turning to FIG. 1, FIG. 1 shows an isometric view of an information-equipped filter 100 according to various aspects of the present disclosure. In one or more embodiments, this information-equipped filter 100 according to the present disclosure has an inner portion and an outer portion. In one embodiment, said inner portion is a honeycomb structure 8 comprised of a tubular shaped body 2 that has a large number of through holes 6 that are placed in parallel with one another with a wall portion 4 interposed therebetween. Moreover, in one embodiment, said inner portion's tubular shaped body 2 has a sealing material layer 17 that is formed on the peripheral portion of said tubular shaped body 2. The sealing material layer 17 is formed to reinforce the peripheral portion of the tubular shaped body 2, adjust the shape, and also improve the heat-insulating property of the information-equipped filter 100. In a further embodiment, no sealing layer is used.

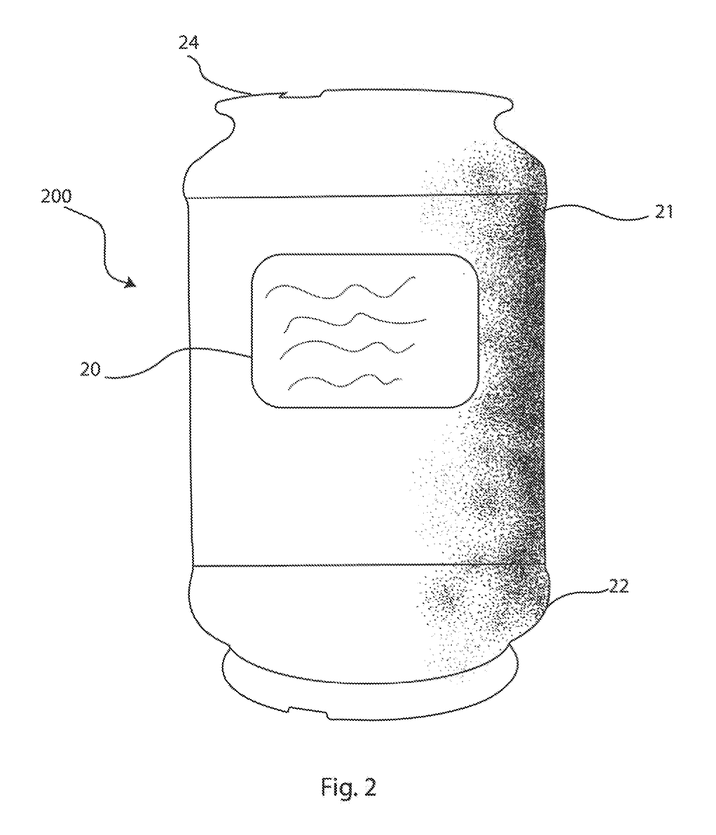

Further, said information-equipped filter has an outer portion, said outer portion comprising an outer shell 11, and, in one non-limiting embodiment, a data label 10 located on the outer surface of said shell 11. In this embodiment, the outer shell is made out of a metal material. In some embodiments, the outer shell 11 can be made out of any material suitable for being the shell of a filter. In one embodiment, said outer portion further comprises one or more connectors, as shown in FIG. 2. In a further embodiment, said attachment clamps include one or more attachment connecting points 15.

In the FIG. 1 embodiment, said inner portion's honeycomb structure 8 is placed inside of said outer portion's outer shell 11. In one embodiment, the sealing material layer 17 is used to seal said honeycomb structure inside of said outer shell in order to prevent any gases from leaking between the outer surface of the honeycomb structure and the inner surface of the outer shell.

Additionally, in the FIG. 1 embodiment, the connector is used to connect the information-equipped filter 100 to a gas inlet. In a further embodiment, the information equipped filter has a second connector on the outlet end of said filter to connect said filter to a gas outlet. In this embodiment, this allows gas and particles, after combustion in an internal combustion engine, to flow through the filter to filter out particulate matter, and out the filter to the exhaust. In these embodiments, the connecting points 15 are used to connect the filter to the connectors.

Further, in a non-limiting embodiment, the tubular shaped body 2 of the honeycomb structure 8 is a cylinder shape. In a further non-limiting embodiment, the tubular shaped body 2 is a square or rectangular shape. Additionally, in this embodiment, the outer shell 11 would be square or rectangular shaped as well.

The honeycomb structure 8 according to the present invention may be any honeycomb structure, and in one non-limiting embodiment it is made of a porous ceramic material and has a structure in which at least one through holes 6 are placed in parallel with one another in the length direction of the tubular shaped body 2. In some embodiments, the filter includes a wall portion 4 interposed therebetween said through holes 6. In some embodiments, the honeycomb structure 8 may include a tubular shaped honeycomb structure body 2 made of a single sintered body in which a large number of through holes are placed in parallel with one another in the length direction with a wall portion interposed therebetween. In another embodiment, the honeycomb structure is configured by a plurality of tubular shaped honeycomb structures which are combined with one another through sealing material layers, each pillar-shaped honeycomb structure having a structure in which a large number of through holes are placed in parallel with one another in the length direction with a partition wall interposed therebetween. In a further embodiment, the honeycomb structure is any structure in a filter suitable to capture particulate matter.

Here, in the honeycomb structure 8 shown in FIG. 1, the wall portion 4 separating the through holes 6 are allowed to function as a particle collecting filter.

In one embodiment, each of the through holes 6 formed in the tubular shaped body 2 are sealed with a plug at either end of its exhaust-gas inlet side and outlet side so that exhaust gases that have entered one through hole 6 are discharged from another through hole, on the opposite side of the filter, after having always passed through the wall portion 4 that separates the through holes 6.

Therefore, the information-equipped filter 100 shown in FIG. 1 is allowed to function as a honeycomb filter for purifying exhaust gases. When the honeycomb structure is allowed to function as the honeycomb filter for purifying exhaust gases, the entire wall portion of the through holes may be configured to function as a particle-collecting filter or only a portion of the wall portion of the through holes may be configured to function as a particle-collecting filter.

Moreover, in the honeycomb structure, in one embodiment, the end portions of the through holes need not necessarily be sealed, and when not sealed, the honeycomb structure can be used as a catalyst supporting member on which, for example, an exhaust gas converting catalyst is supported.

In one embodiment of the information-equipped filter 100, each end of the filter is covered with an end cap. These end caps can be a mesh design or wire material as to allow air to flow through the filter. These end caps serve the purpose of helping to keep the honeycomb structure 8 inside of the outer shell 11.

In one embodiment, the information-equipped filter 100 does not have an outer shell 11, and the information label 10 is applied directly to the sealing material layer 17.

FIG. 2 is a front view of an exemplary information-equipped filter 200 according to various aspects of the present disclosure. In this embodiment, a top connector 24, an outer shell 21, a data label 20, and a bottom connector 22 are shown.

FIG. 2 is a front view of an exemplary information-equipped filter 200 according to various aspects of the present disclosure.

The connectors, the top connector 24 and bottom connector 22, can be a metal strap, metal tension strips, metal weather-stripping, metal with a screw threading, or any other commonly used connecting points on an automotive filter.

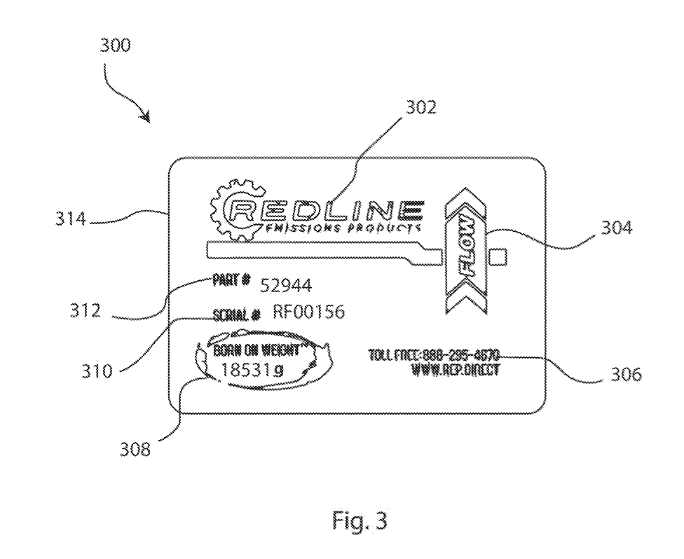

FIG. 3 is a front view of a data label 300 according to various aspects of the present disclosure. In this embodiment, the data label 300 is printed onto a piece of metal 314. In the FIG. 3 embodiment the label is square shaped, but in other embodiments any shape can be used. In a further embodiment, the information is stamped, etched, lasered, printed, written, or any commonly used method of recording information onto a label. Additionally, in another embodiment, the data label is made out of paper, plastic or any other commonly used label material. In one embodiment, the data label includes any one of the following: the manufacturer of the filter's product name or brand name 304, the part number 312 used by the manufacturer to identify the model of the information-equipped filter, the serial number 310 used by the manufacture to identify that unique filter, the company name 302, company contact information 306 and the born-on weight 308.

The born-on weight 308 is the weight of the filter's inner portion of the information-equipped filter, including the inner portion's honeycomb structure, such as honeycomb structure 8 in FIG. 1, and the outer portion's outer shell, such as outer shell 11 of FIG. 1, and data label, such as data label 10 of FIG. 1, after moisture has been removed from the filter by heating the filter on the date said filter was manufactured. In some embodiments, the born-on weight also includes the filter's one or more connectors 24, 22 or the one or more connector points 15. In another embodiment, the moisture is not removed from the filter by heating it, but instead is removed by any commonly known method of removing moisture. In a further non-limiting embodiment, the born-on weight does not include the weight of the data label 10, and the data label is applied to the outer shell later.

In one embodiment, the weight of the information-equipped filter on the date it was manufactured, after the moisture is removed, is applied to the filter's data label.

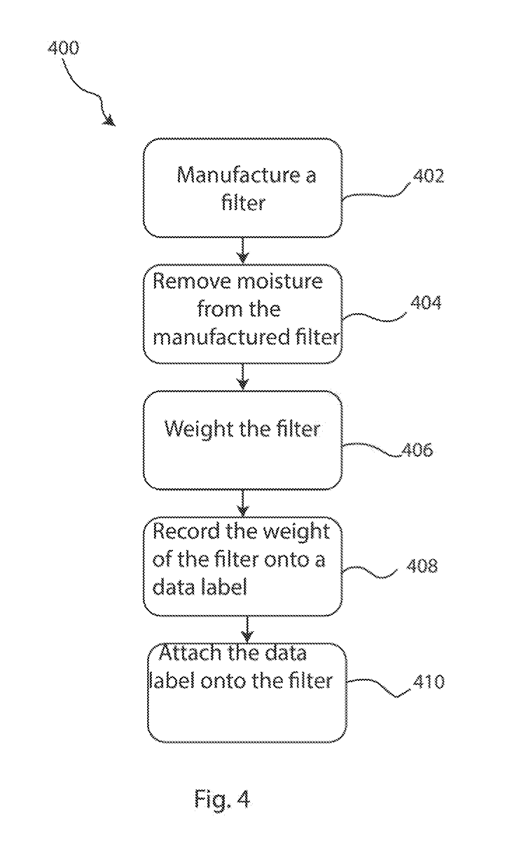

FIG. 4 depicts a diagram 400 showing the operational steps taken to apply the manufacturing weight onto a filter according to various aspects of the present disclosure. Automotive filters in combustion engines, especially diesel particulate filters, need to be cleaned every 75,000-150,000 miles. Often the shop cleaning these filters do not know what these filters weighed when they were brand new, and therefore are unable to tell when the filter is cleaned because they cannot tell how many more grams of soot and ash remain in the filter.

The first step in solving the problem begins with step 402 with the manufacturing of a filter. The step requires the manufacturing of a filter before the data label is applied. The manufactured filter includes the inner portion's honeycomb structure, and also includes said honeycomb structure inserted into the outer shell. In some embodiments, the manufactured filter includes the one or more connectors, and can also include the one or more connecting points and the data label.

After the filter is manufactured, step 404 requires the removal of the moisture from the filter. Before a filter can be weighed, the moisture must be removed to give an accurate accounting of the manufactured weight of the filter on the date it was manufactured. This is known as the born-on weight. This is done in order to provide an accurate weight so a cleaner knows the weight of the filter not including any accumulated moisture from the atmosphere into the filter.

Removing the moisture is accomplished by heating the manufactured filter to temperature to remove all moisture. In some embodiments, it may not be possible to remove 100% of the moisture, but a substantial amount of the moisture is removed instead. A substantial amount includes all moisture capable of being removed by a filter by heating it above 100 degrees Fahrenheit.

In some embodiments, the moisture is not removed by heating, but instead is removed by any other commonly used methods to remove moisture.

After the excess moisture is removed from the filter, the filter is then weighed in step 406. This weighing is done soon after the moisture is removed, because the filter can accumulate moisture again if the filter sits too long after moisture removal. In some embodiments the weighing of the filter includes all components of the filter outlined in FIG. 1 above. In another embodiment, the weighing of the filter does not include the weight of the data label 10. In a further embodiment, the weighing of the filter does not include the one or more connectors 13 or the one or more clamps 15. In a further embodiment, only the inner portion of the filter is weighed and not the outer portion.

In one embodiment, the filter is weighed with the data label 10 sitting on the scale with the filter, so the filter can be etched immediately after weighing and attached to the filter.

After the filter is weighed, the weight of the filter is recorded and applied to a data label 10 in step 408. In one embodiment, the data label is a square piece of metal 10. In a further embodiment, the information is stamped, etched, lasered, printed, written, or any commonly used method of recording information onto a label. Additionally, in another embodiment, the data label is made out of paper or any other commonly used label material. This data label can include any one of the following: the company's name, the part number used by a company to identify the model of the information-equipped filer, the company contact information, the serial number, the product name and the recorded weight from step 406.

The final step includes attaching the data label onto the filter in step 410. In one embodiment, the data label is spot welded onto the circumference of the outer shell of the information-equipped filter. In another embodiment, the data label is applied to the filter by use of adhesive, or any other attachment means commonly used to attach a label. In a further embodiment, the data label is attached to the sealing material on the tubular shaped body, and not the outer shell.

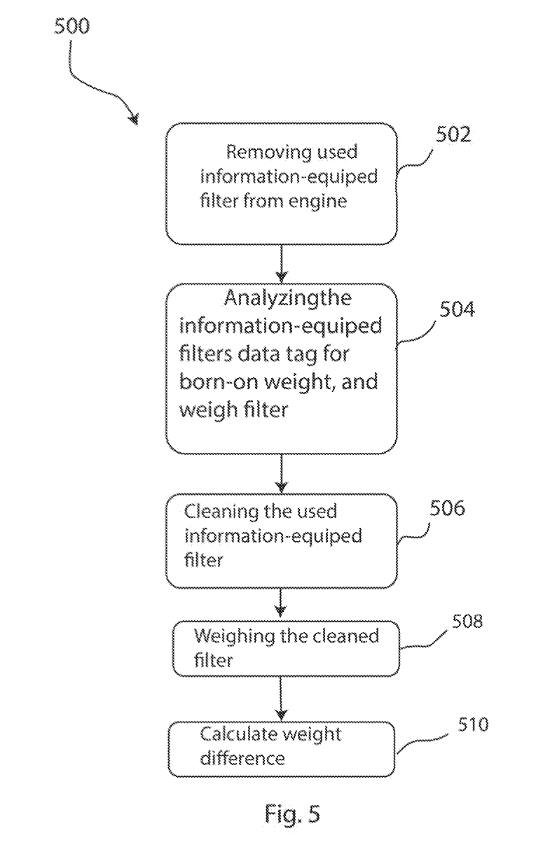

FIG. 5 is a flow chart 500 for an exemplary process for determining how much soot and ash is removed from a diesel particulate filter that is information-equipped, such as the filter in FIG. 1, after cleaning. The process may begin, for example, at step 502, by a mechanic or a user determining whether accumulated soot or ash is present in a used information-equipped filter. Generally, on diesel trucks, a diesel particulate filter needs to be cleaned to remove any soot and ash buildup every 75,000 to 150,000 miles. The filter must first be removed from an engine, or exhaust system. This can be accomplished by removing the information-equipped filter by disconnecting the one or more connectors, and in some embodiments the one or more connecting points, from both the gas inlet and the gas outlet end of the filter.

Once the filter is removed, the mechanic or user will analyze the data label located on the information-equipped diesel particulate filter in order to determine the weight of the filter on the day it was manufactured in step 504. This information is recorded for each individual information-equipped filter manufactured onto its data label after moisture has been substantially removed. Substantially removed generally means how much moisture is able to be removed from said filter after heating it to roughly 100 degrees Fahrenheit.

Once the weight of the information-equipped filter at the time it was first manufactured, and without excess moisture, soot, and ash is known, the mechanic or user can weigh the scale to determine the weight of the removed used filter. In step 506, the mechanic or user cleaning the information-equipped filter wants to clean the removed used filter and clean out enough soot and then weigh the cleaned filter in step 508. In step 510, the user calculates the difference between the born-on weight and the clean filter weight of step 508. The user or mechanic will want to clean out enough ash until said filter's weight is within 100 grams of said weight listed on the data label in step 504. The soot and ash will be stuck inside the honeycomb structure of the filter, and the mechanic or user cannot see how dirty the filter is on the interior. Once the information-equipped filter is cleaned within that weight range to said data label, the mechanic or user will know that the information-equipped filter has been substantially cleaned.

Accordingly, one or more embodiments described herein for an information-equipped filter may be used to clean out harmful soot and ash from the filter. The various embodiments provide numerous benefits that overcome shortcomings and disadvantages of existing methods.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description but is not intended to be exhaustive or limited to the invention in the form disclosed. Many modifications and variations will be apparent to those of ordinary skill in the art without departing from the scope and spirit of the invention. The embodiments were chosen and described in order to best explain the principles of the invention and the practical application, and to enable others of ordinary skill in the art to understand the invention for various embodiments with various modifications as are suited to the particular use contemplated. The present invention according to one or more embodiments described in the present description may be practiced with modification and alteration within the spirit and scope of the appended claims. Thus, the description is to be regarded as illustrative instead of restrictive of the present invention.

What is claimed is:

1. An information-equipped filter comprising:
an inner portion comprising a honeycomb structure, said honeycomb structure comprising a body made of a porous ceramic material having at least one channel extending therethrough, wherein said honeycomb structure is configured to filter soot and ash out of automotive exhaust;
an outer portion comprising an outer shell;
a data label attached to said outer shell, and
visual indicia formed on said data label wherein the visual indicia provides information concerning the filter's weight at the time it was manufactured allowing a user to measure how much soot and ash is in a used filter.

2. The information-equipped filter of claim 1, further comprising a sealing layer that is located between said inner portion and said outer portion.

3. The information-equipped filter of claim 1, wherein said outer portion further comprises a top and bottom connector.

4. The information-equipped filter of claim 1, wherein said visual indicia is formed on said data label by one of the following methods: stamping, etching, lasering, printing, or writing.

5. The information-equipped filter of claim 1, wherein said data label is a metal square.

6. The information-equipped filter of claim 1, wherein said data label is spot welded onto the outer circumference of the outer shell

7. The information-equipped filter of claim 1, wherein said data label is attached to said outer shell with an adhesive.

8. The information-equipped filter of claim 1, wherein said outer shell is made out of metal.

9. The information-equipped filter of claim 1, wherein said filter further comprises one more connector piece configured to allow attachment of at least one connector to the outer shell.

10. A method for applying the weight of a particulate filter on the day it was manufactured onto said particulate filter, the method comprising:
(a) heating the particulate filter, wherein said heat removes any moisture from the filter;
(b) weighing the filter;
(c) recording said weight of said filter onto a data label; and
(d) attaching said data label onto the side of the exterior of said particulate filter.

11. The method of claim 10, further comprising the first step of manufacturing a particulate filter that is comprised of an inner portion and an outer portion, wherein said inner portion is further comprised of a honeycomb structure and said honeycomb structure comprising a body made of a porous ceramic material having at least one channel extending therethrough, wherein said honeycomb structure is configured to filter soot and ash out of automotive exhaust, and said out portion further comprising an outer shell.

12. The method of claim 11, wherein said moisture is any moisture that is present in the particulate filter due to the manufacturing process and in the atmosphere.

13. The method of claim 11, wherein said data label is weighed on the same scale as the particulate filter, and wherein the recording of the particulate filter weight is recorded on the data label before it is attached.

14. The method of claim 11, wherein the weight of the scale either does not include the data label or a known data label is weight is added to the weight of the particulate filter before it is recorded.

15. The method of claim 11, wherein said data label is metal and is spot welded onto the exterior of said outer shell.

16. A method for determining how much soot and ash is removed from a diesel particulate filter after cleaning, the method comprising:
(a) removing a used diesel particulate filter having the weight on the day it was manufactured recorded onto a data tag located on an outer circumference of said diesel particulate filter; wherein said weight was recorded after being heated to at least 100 degrees Fahrenheit;
(b) analyzing said data tag to learn the filter's weight on the day it was manufactured;
(c) weighting the used diesel particulate filter;
(c) cleaning the used diesel particulate filter;
(d) weigh the cleaned diesel particulate filter;
(e) calculating the difference between cleaned diesel particulate filter weight and the weight of said used diesel particulate filter on the day it was manufactured.

17. The method of claim 16, further comprising the step of reinstalling the diesel particulate filter if said calculation is within 100 grams.

18. The method of claim 16, wherein steps (c) through (e) are repeated if the calculation in step (e) is more than 100 grams.
